(19) United States
(12) Patent Application Publication
(10) Pub. No.: US 2013/0155057 A1
(43) Pub. Date: Jun. 20, 2013

(54) THREE-DIMENSIONAL INTERACTIVE DISPLAY APPARATUS AND OPERATION METHOD USING THE SAME

(71) Applicant: AU OPTRONICS CORP., Hsin-Chu (TW)

(72) Inventors: Guo-Zhen WANG, Hsin-Chu (TW); Ming-Ching MA, Hsin-Chu (TW); Shuan-Yu TUNG, Hsin-Chu (TW); Shu-Yi HUANG, Hsin-Chu (TW); Yi-Pai HUANG, Hsin-Chu (TW); An-Thung CHO, Hsin-Chu (TW); Jiun-Jye CHANG, Hsin-Chu (TW)

(73) Assignee: AU OPTRONICS CORP., Hsin-Chu (TW)

(21) Appl. No.: 13/711,715

(22) Filed: Dec. 12, 2012

(30) Foreign Application Priority Data
Dec. 20, 2011 (TW) 100147467

(51) Int. Cl. G06T 15/00

(52) U.S. Cl. CPC G06T 15/00
USPC 345/419

(57) ABSTRACT

A three-dimensional interactive display apparatus includes a display panel, two light source generators and a processing circuit. The two light source generator generators are configured to respectively emit two lights according to a predetermined sequence, and emission periods of the two second light source generators are configured to not overlap. The processing circuit is configured to sequentially obtain a plurality of images through sensing the two lights by a plurality light sensors, determine the corresponding light source generator of each one image according to the predetermined sequence, and further determine position information of the corresponding light source generator according to image information of the one image. An operation method of the aforementioned three-dimensional interactive display apparatus is also provided.

### TECHNICAL FIELD

The disclosure relates to a touch control technical field, and more particularly to a three-dimensional interactive display apparatus and an operation using the same.

### BACKGROUND

Generally, a user can operate a light-sensor-based three-dimensional interactive display apparatus via a light source generator (for example, a light pen) thereof. While the light source generator projecting lights on a display panel of the three-dimensional interactive display apparatus, the three-dimensional interactive display apparatus can capture the images on the display panel through the light sensors so as to determine the position information of the light source generator according to the light spots of the captured images; wherein the position information includes, for example, a two-dimensional position or a distance of the light source generator relative to a display surface of the display panel.

However, if the three-dimensional interactive display apparatus is being simultaneously operated with two or more light source generators, the three-dimensional interactive display apparatus may not, due to unable to distinguish these light source generators, interact successfully with these light source generators. In other words, the conventional three-dimensional interactive display apparatus cannot perform a multi-point interactive operation.

### SUMMARY OF EMBODIMENTS

Therefore, one object of the present disclosure is to provide a three-dimensional interactive display apparatus capable of performing a multi-point interactive operation.

Another object of the present disclosure is to provide an operation method applicable to the aforementioned three-dimensional interactive display apparatus.

An embodiment of the present disclosure provides a three-dimensional interactive display apparatus, which includes a display panel, a first light source generator, a second light source generator and a processing circuit. The display panel includes a plurality of light sensors. The first light source generator and the second light source generator are configured to respectively emit a first light and a second light according to a predetermined sequence, and emission periods of the first light source generator and the second light source generator are configured to not overlap. The processing circuit is electrically connected to the light sensors and configured to sequentially obtain a plurality of images through sensing the first light and the second light by the light sensors, determine the corresponding light source generator of each one image according to the predetermined sequence, and further determine position information of the corresponding light source generator according to image information of the one image.

Another embodiment of the present disclosure provides an operation method of a three-dimensional interactive display apparatus. The three-dimensional interactive display apparatus includes a display panel, a first light source generator and a second light source generator. The display panel includes a plurality of light sensors. The first light source generator and the second light source generator are configured to respectively emit a first light and a second light according to a predetermined sequence, and emission periods of the first light source generator and the second light source generator are configured to not overlap. The operation method includes steps of: sequentially obtaining a plurality of images through sensing the first light and the second light by the light sensors; and determining the corresponding light source generator of each one image according to the predetermined sequence, and further determining position information of the corresponding light source generator according to image information of the one image.

In summary, through configuring a plurality of light source generators to sequentially emit lights according to a predetermined sequence and the emission periods thereof are configured not to overlap, the three-dimensional interactive display apparatus according to the present disclosure can, while the lights are being projected on a display panel of the three-dimensional interactive display apparatus, sequentially obtain a plurality of images via a processing circuit thereof driving a plurality of light sensors in the display panel to sense the lights, and the processing circuit can determine the corresponding light source generator of each one image according to the predetermined sequence, so as to further determine position information of the corresponding light source generator according to image information of the one image. Thus, the three-dimensional interactive display apparatus according to the present disclosure can distinguish the light source generators and thereby being capable of performing a multi-point interactive operation.

### BRIEF DESCRIPTION OF THE DRAWINGS

The above embodiments will become more readily apparent to those ordinarily skilled in the art after reviewing the following detailed description and accompanying drawings, in which:

FIG. 1 is a schematic view of a three-dimensional interactive display apparatus in accordance with a preferred embodiment of the present disclosure;

FIG. 2 is a schematic sequence view of three signals associated with the three-dimensional interactive display apparatus in FIG. 1;

FIG. 3 is a schematic view of a three-dimensional interactive display apparatus in accordance with another preferred embodiment of the present disclosure;

FIG. 4 is a schematic cross-sectional view of another display panel; and

FIG. 5 is a schematic flow chart of an operation method of a three-dimensional interactive display apparatus in accordance with an embodiment of the present disclosure.

### DETAILED DESCRIPTION OF EMBODIMENTS

The disclosure will now be described more specifically with reference to the following embodiments. It is to be noted that the following descriptions of preferred embodiments are presented herein for purpose of illustration and description only. It is not intended to be exhaustive or to be limited to the precise form disclosed.

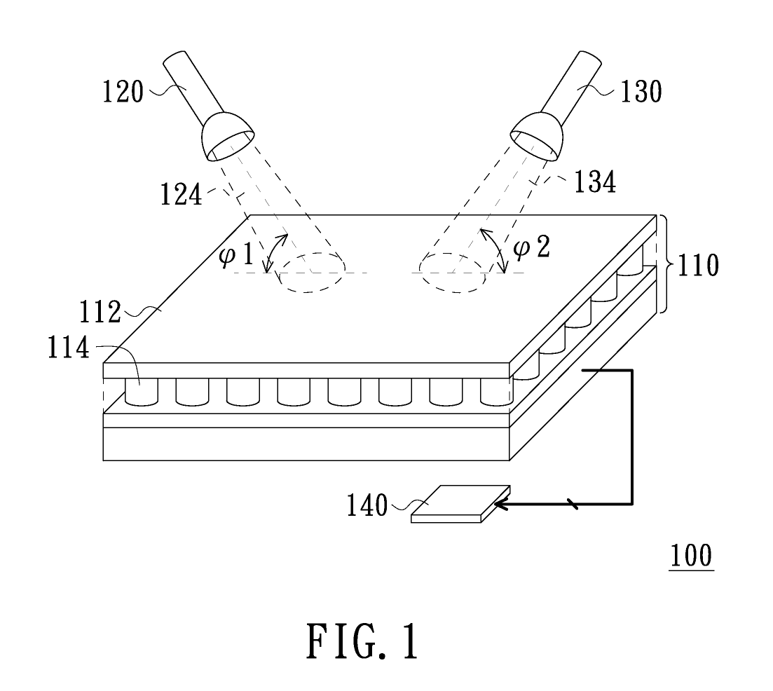

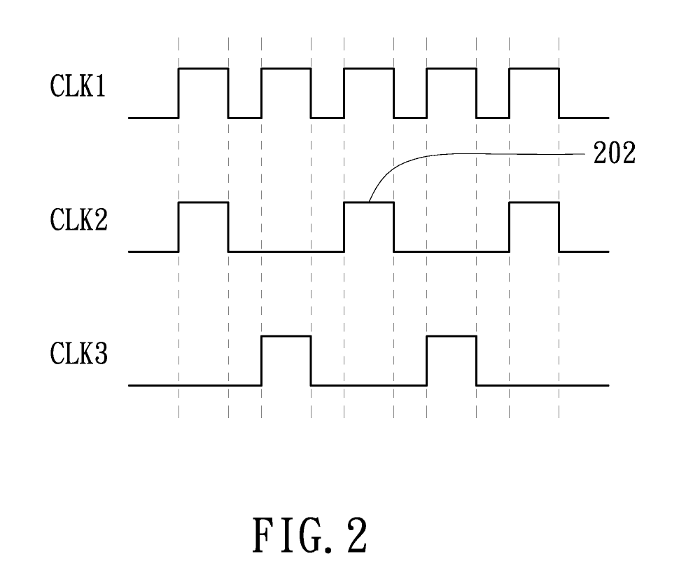

FIG. 1 is a schematic view of a three-dimensional interactive display apparatus in accordance with a preferred embodiment of the present disclosure. As shown, the three-dimensional interactive display apparatus 100 includes a display panel 110, two light source generators 120, 130 and a processing circuit 140. The display panel 110 includes a display surface 112 and a plurality of light sensors 114 disposed in the display panel 110 in a matrix manner. The light source generators 120, 130 are configured to respectively emit lights 124, 134 according to a predetermined sequence; specifically, in the predetermined sequence the emission periods of the light source generators 120, 130 are configured not to overlap. The processing circuit 140, electrically connected to the light sensors 114, is configured to sequentially obtain a plurality of images through driving the light sensors 114 to sense the lights 124, 134. The emission periods of the light source generators 120, 130 as well as the time points of the processing circuit 140 obtaining the images will be described in detail in FIG. 2.

FIG. 2 is a schematic sequence view of three signals associated with the processing circuit 140 and the light source generators 120, 130. Please refer to FIGS. 1, 2 both. The clock signal CLK1 is configured to determine the processing circuit 140 whether or not to drive the light sensors 114 to perform a sensing operation. In this embodiment, the processing circuit 140 drives the light sensors 114 to perform the sensing operation in response to a logic-high clock signal CLK1; and alternatively, the processing circuit 140 does not drive the light sensors 114 to perform the sensing operation in response to a logic-low clock signal CLK1. The clock signal CLK2 is configured to determine the light source generator 120 whether or not to emit the light 124. In this embodiment, the light source generator 120 emits the light 124 in response to a logic-high clock signal CLK2; and alternatively, the light source generator 120 does not emit the light 124 in response to a logic-low clock signal CLK2. The clock signal CLK3 is configured to determine the light source generator 130 whether or not to emit the light 134. In this embodiment, the light source generator 130 emits the light 134 in response to a logic-high clock signal CLK3; and alternatively, the light source generator 130 does not emit the light 134 in response to a logic-low clock signal CLK3.

As illustrated in FIG. 2, the clock signals CLK2, CLK3 both are configured to have a frequency smaller than the clock signal CLK1 has; the enable-period of each pulse (for example, pulse 202) of both the clock signals CLK2, CLK3 is configured to overlap at least a portion of the enable-period of one pulse of the clock signal CLK1; and the enable-period of each pulse (for example, pulse 202) of the clock signal CLK2 is configured not to overlap the enable-period of any pulse of the clock signal CLK3.

Because these images are sequentially obtained according to the predetermined sequence (a sequence associated with the clock signals CLK1, CLK2 and CLK3), the processing circuit 140 can determine that each obtained image is derived from the light source generator 120 or from the light source generator 130 according to the predetermined sequence, so as to further determine the position information of the light source generators 120, 130 according to image information contained in the obtained images.

The aforementioned position information includes a two-dimensional position and/or a distance of the light source generator 120 (or 130) relative to the display surface 112 of the display panel 110; specifically, the distance of the light source generator 120 (or 130) relative to the display surface 112 can be calculated based on the light spot's size contained in the images. In addition, the processing circuit 140 can further determine the angle φ1 (or φ2) of the traveling direction of the light 124 (or 134) relative to the display surface 112 of the display panel 110 according the image information (for example, the aspect ratio of light spot contained in the images). Thus, the three-dimensional interactive display apparatus 100 according to this embodiment can, through the aforementioned design, distinguish the two light source generators 120, 130 and thereby being capable of performing the multi-point interactive operation.

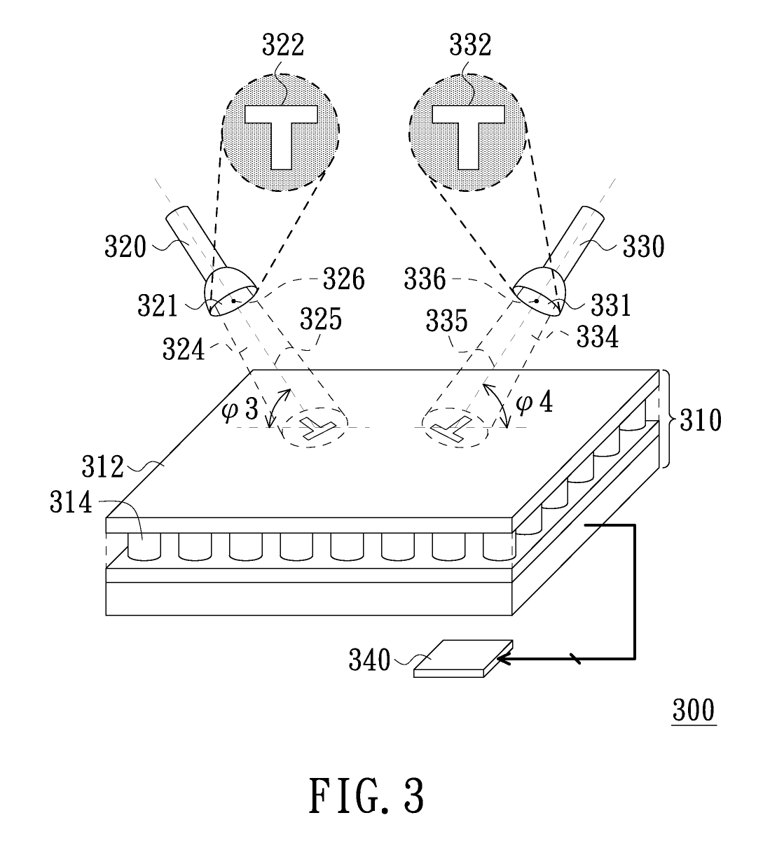

In addition, the light source generator may be designed to have a specific pattern on its light emission surface; and thus the processing circuit can, due to the pattern accordingly being projected on a surface while the surface is being emitted by the light from the light source generator, determine the rotation angle of the light source generator relative to its axis according to the projected pattern. FIG. 3 is a schematic view of a three-dimensional interactive display apparatus in accordance with another preferred embodiment of the present disclosure. As shown, the three-dimensional interactive display apparatus 300 includes a display panel 310, two light source generators 320, 330 and a processing circuit 340. The display panel 310 includes a display surface 312 and a plurality of light sensors 314. The light source generator 320 includes a light emission surface 321 with a pattern 322 (herein is exemplified by a T-shaped pattern). The formation mean of the pattern 322 is, for example, blackening the all light emission surface 321 except the area of the pattern 322; as such, only the area within the pattern 322 can be passed through by lights. Because the light source generator 320 is configured to emit the light 324 via the light emission surface 321, a pattern image corresponding to the T-shaped pattern 322 is correspondingly projected on the display surface 312.

Similarly, the light source generator 330 also includes a light emission surface 331 with a pattern 332 (for example, a T-shaped pattern have a size same as that of the pattern 322). The formation mean of the pattern 332 is, for example, blackening the all light emission surface 331 except the area of the pattern 332; as such, only the area within the pattern 332 can be passed through by lights. Because the light source generator 330 is configured to emit the light 334 via the light emission surface 331, a pattern image corresponding to the T-shaped pattern 332 is correspondingly projected on the display surface 312. In addition, the light source generators 320, 330 are configured to respectively emit the lights 324, 334 according to a predetermined sequence; wherein in the predetermined sequence the emission periods of the light source generators 320, 330 are configured not to overlap. As such, the processing circuit 340 can sequentially obtain a plurality of images through driving the light sensors 314 to sense the lights 324, 334.

Because these images are sequentially obtained according to the predetermined sequence, the processing circuit 340 can determine that each image is derived from the light source generator 320 or from the light source generator 330 according to the predetermined sequence, so as to further determine the position information of the light source generators 320, 330 according to the image information contained in the obtained images.

In addition, the processing circuit 140 can further, according to the image information, determine the angle φ3 (or φ4) of the traveling direction of the light 324 (or 334) relative to the display surface 312 of the display panel 310 and/or the rotation angle of the light source generator 320 (or 330) relative to its axis 325 (or 335); wherein the axes 325, 335 are configured to be perpendicular to the light emission surfaces 321, 331 and pass through the central points 326, 336 of the light emission surfaces 321, 331, respectively. As illustrated in FIG. 3, the light source generator 320 can rotate along its axis 325 and simultaneously the associated projected T-shaped pattern rotates correspondingly; similarly, the light source generator 330 can rotate along its axis 335 and simultaneously the associated projected T-shaped pattern rotates correspondingly.

By using, for example, the aspect ratio of the projected pattern contained in the obtained images, the processing circuit 340 can determine the angle φ3 (or φ4) of the traveling direction of the light 324 (or 334) relative to the display surface 312 of the display panel 310. Moreover, by designing the two pattern 322, 332 each to have a non-symmetry feature, the processing circuit 340 can further determine the rotation angel of the light source generator 320 (or 330) relative to the axis 325 (or 335) through the rotation angel of the projected pattern contained in the images.

The aforementioned three-dimensional interactive display apparatuses each are exemplified by including two light source generators; however, it is understood that the three-dimensional interactive display apparatus according to the present disclosure is not limited to the number of the light source generators. In other words, the three-dimensional interactive display apparatus of the present disclosure may be developed to equip with three or more light source generators.

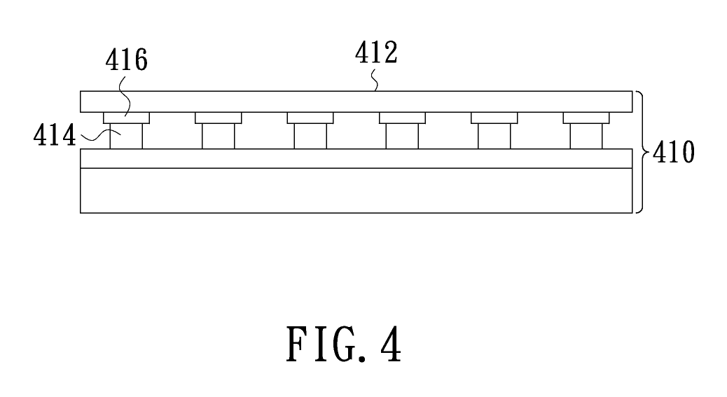

To avoid affecting the images displayed on a display panel, it is to be noted that the light source generator can be configured to emit infrared lights; and correspondingly an infrared filter device is required to be disposed in the display panel, as illustrated in FIG. 4. FIG. 4 is a schematic cross-sectional view of another display panel. As shown, the display panel 410 further, beside a display surface 412 and a plurality of light sensors 414, includes a plurality of infrared filter devices 416; wherein only the infrared light can pass through the infrared filter device 416, and each light sensor 414 is configured to sense the images on the display surface 412 through its associated infrared filter device 416. In addition, it is understood that the display panel 410 is not required to be disposed with the infrared filter devices 416 if the light sensors 414 each are specifically configured to sense infrared lights only. In addition, the display panel 410 is required to be disposed with various light filter devices if the associated light source generators (not shown) are configured to emit lights with various colors; wherein it is to be noted that each light filter device can be passed through by one specific color light only, and each light sensor can sense the image only through its associated light filter device.

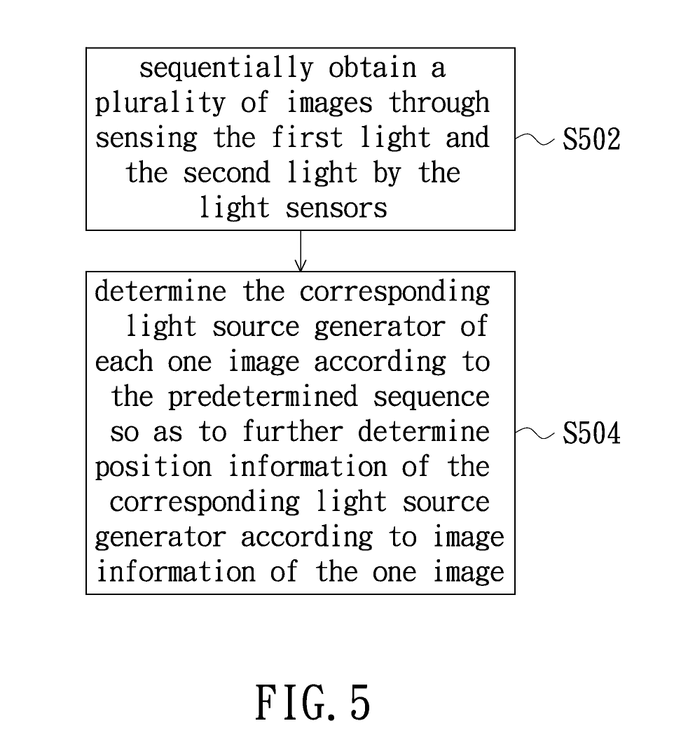

The operation method of the three-dimensional interactive display apparatus according to the present disclosure can be summarized to have some basic operation steps as illustrated in FIG. 5, which is a schematic flow chart of an operation method of a three-dimensional interactive display apparatus in accordance with an embodiment of the present disclosure. Herein, the three-dimensional interactive display apparatus includes a display panel, a first light source generator and a second light source generator; the display panel includes a plurality of light sensors; the first light source generator and the second light source generator are configured to respectively emit a first light and a second light according to a predetermined sequence, and the emission periods of the first light source generator and the second light source generator are configured to not overlap. As illustrated in FIG. 5, the operation method includes steps of: sequentially obtaining a plurality of images through sensing the first light and the second light by the light sensors (step 502); and determining the corresponding light source generator of each one image according to the predetermined sequence, and further determining position information of the corresponding light source generator according to image information of the one image (step 504).

In summary, through configuring a plurality of light source generators to sequentially emit lights according to a predetermined sequence and the emission periods thereof are configured not to overlap, the three-dimensional interactive display apparatus according to the present disclosure can, while the lights are being projected on a display panel of the three-dimensional interactive display apparatus, sequentially obtain a plurality of images via a processing circuit thereof driving a plurality of light sensors in the display panel to sense the lights, and the processing circuit can determine the corresponding light source generator of each one image according to the predetermined sequence, so as to further determine position information of the corresponding light source generator according to image information of the one image. Thus, the three-dimensional interactive display apparatus according to the present disclosure can distinguish the light source generators and thereby being capable of performing a multi-point interactive operation.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A three-dimensional interactive display apparatus, comprising:
a display panel comprising a plurality of light sensors;
a first light source generator;
a second light source generator, wherein the first light source generator and the second light source generator are configured to respectively emit a first light and a second light according to a predetermined sequence, and emission periods of the first light source generator and the second light source generator are configured to not overlap; and
a processing circuit electrically connected to the light sensors and configured to sequentially obtain a plurality of images through sensing the first light and the second light by the light sensors, determine the corresponding light source generator of each one image according to the predetermined sequence, and further determine position information of the corresponding light source generator according to image information of the one image.

2. The three-dimensional interactive display apparatus according to claim 1, wherein the processing circuit is further configured to determine whether or not to drive the light sensors to perform a sensing operation according to the level of a first clock signal, the first light source generator is configure to determine whether or not to emit the first light according to the level of a second clock signal, and the second light source generator is configured to determine whether or not to emit the second light according to the level of a third clock signal; wherein the second clock signal and the third clock signal both are configured to have a frequency smaller than the frequency of the first clock signal has, the enable-period of each pulse of both the second clock signal and the third clock signal is configured to overlap at least a portion of the enable-period of one pulse of the first clock signal, and the enable-period of each pulse of the second clock signal is configured not to overlap the enable-period of any pulse of the third clock signal.

3. The three-dimensional interactive display apparatus according to claim 1, wherein the position information includes a two-dimensional position of the corresponding light source generator relative to a display surface of the display panel and/or a distance of the corresponding light source generator relative to the display surface of the display panel.

4. The three-dimensional interactive display apparatus according to claim 1, wherein the processing circuit is further configured to determine, according to the image information of the one image, an angle of a traveling direction of the light emitted from the corresponding light source generator relative to a display surface of the display panel.

5. The three-dimensional interactive display apparatus according to claim 1, wherein the light source generators each has a light-emission surface with a pattern thereon, and the shape of the pattern is simultaneously presented on a surface being projected by the corresponding light, and the processing circuit is further configured to determine, according to the image information of the one image, an angle of a travelling direction of the light emitted from the corresponding light source generator relative to a display surface of the display panel and/or a rotation angle of the corresponding light source generator along an axis thereof, the axis is configured to be perpendicular to a light-emission surface of the light source generator and pass through a center of the light-emission surface.

6. The three-dimensional interactive display apparatus according to claim 1, wherein the first light has first color, the second light has second color, the display panel is further disposed with a plurality of first light filter devices and a plurality of second light filter devices, the first light filter device is configured to be passed through by the first light only, the second light filter device is configured to be passed through by the second light only, and the light sensors each are configured to sense the images through either the first light filter device or the second light filter device.

7. An operation method of a three-dimensional interactive display apparatus, the three-dimensional interactive display apparatus comprising a display panel, a first light source generator and a second light source generator, the display panel comprising a plurality of light sensors, the first light source generator and the second light source generator being configured to respectively emit a first light and a second light according to a predetermined sequence, and emission periods of the first light source generator and the second light source generator being configured to not overlap, the operation method comprising:
sequentially obtaining a plurality of images through sensing the first light and the second light by the light sensors; and
determining the corresponding light source generator of each one image according to the predetermined sequence, and further determining position information of the corresponding light source generator according to image information of the one image.

8. The operation method according to claim 7, wherein the light sensors are configured to determine whether or not to perform a sensing operation according to the level of a first clock signal, the first light source generator is configure to determine whether or not to emit the first light according to the level of a second clock signal, and the second light source generator is configured to determine whether or not to emit the second light according to the level of a third clock signal; wherein the second clock signal and the third clock signal both are configured to have a frequency smaller than the first clock signal has, the enable-period of each pulse of both the second clock signal and the third clock signal is configured to overlap at least a portion of the enable-period of one pulse of the first clock signal, and the enable-period of each pulse of the second clock signal is configured not to overlap the enable-period of any pulse of the third clock signal.

9. The operation method according to claim 7, wherein the position information includes a two-dimensional position of the corresponding light source generator relative to a display surface of the display panel and/or a distance of the corresponding light source generator relative to the display surface of the display panel.

10. The operation method according to claim 7, further comprising:
determining, according to the image information of the one image, an angle of a traveling direction of the light emitted from the corresponding light source generator relative to a display surface of the display panel.

11. The operation method according to claim 7, wherein the light source generators each have a light-emission surface with a pattern thereon, and the shape of the pattern is simultaneously presented on a surface being projected by the corresponding light, and the operation method further comprises:
determining, according to the image information of the one image, an angle of a travelling direction of the light emitted from the corresponding light source generator relative to a display surface of the display panel and/or a rotation angle of the corresponding light source generator along an axis thereof, the axis is configured to be perpendicular to a light-emission surface of the light source generator and pass through a center of the light-emission surface.

12. The operation method according to claim 7, wherein the first light has first color, the second light has second color, the display panel is further disposed with a plurality of first light filter devices and a plurality of second light filter devices, the first light filter device is configured to be passed through by the first light only, the second light filter device is configured to be passed through by the second light only, and the light sensors each are configured to sense the images through either the first light filter device or the second light filter device.

13. An operation method of a three-dimensional interactive display apparatus, comprising:
sequentially obtaining a plurality of images through sensing a first light and a second light according to a predetermined sequence, wherein the first light and the second light are from a plurality of light generators; and
determining a corresponding light source generator of each image according to the predetermined sequence.

14. The operation method according to claim 13, wherein an emission period of the first light generator and an emission period of the second light generator are non-overlapped.

15. The operation method according to claim 13, wherein determining a corresponding light source generator of each image according to the predetermined sequence comprising identifying where the light from the plurality of light generators comes from according to the predetermined sequence.
